(19) United States
(12) Patent Application Publication
(10) Pub. No.: US 2023/0154427 A1
(43) Pub. Date: May 18, 2023

(54) ARRAY SUBSTRATE AND DISPLAY DEVICE

(71) Applicant: TCL China Star Optoelectronics Technology Co., Ltd., Shenzhen, Guangdong (CN)

(72) Inventors: Tianhong WANG, Shenzhen, Guangdong (CN); Yunxiao ZHONG, Shenzhen, Guangdong (CN); Ilgon KIM, Shenzhen, Guangdong (CN)

(73) Assignee: TCL China Star Optoelectronics Technology Co., Ltd., Shenzhen, Guangdong (CN)

(21) Appl. No.: 16/976,775

(22) PCT Filed: Aug. 4, 2020
(86) PCT No.: PCT/CN2020/106744

§ 371 Date: Aug. 31, 2020

(30) Foreign Application Priority Data
Jul. 7, 2020 (CN) 202010647394.5

(51) Int. Cl. G09G 3/36

(52) U.S. Cl. CPC G09G 3/3677; G09G 3/3688; G09G 2320/0233

(57) ABSTRACT

The present invention discloses an array substrate and a display device. The present invention employs a flip pixel framework of a DD+G wiring method, and a design of disposing a GOA circuit on a source electrode driver side. Because two of the data lines adjacently and parallelly enter an AA region, the gate electrode fanout wire and the two data lines are not adjacent to each other but parallelly extend in AA region, which prevents coupling between the gate electrode fanout wire and the data lines signal. The method of using the width of two pixel units to perform a layout of a GOA circuit of one level further facilitates achievement of the narrow border.

### FIELD OF INVENTION

The present invention relates to a field of display technologies, especially relates to an array substrate and a display device.

### BACKGROUND OF INVENTION

Liquid crystal display (LCD) devices have advantages of light weight, low consumption, low working voltage without radiation, and are used extensively in fields of computer displays, television displays, mobile phones.

With constant development of liquid crystal display technologies, people has increasing demands to display devices. In response the market demands, large size, high resolution, ultra-narrow border (UNB) have become market trends. The ultra-narrow border means further compression a width of a border region to achieve further expansion of an area of an effective display region (active area, AA). The demands for the ultra-narrow border poses a higher challenge to LCD design and manufacturing.

In recent years, the spliced display, which has received widespread market attention, has put forward a demand for the extremely narrow border technology. Spliced gaps have been reduced extremely, a requirement of a gap from AA to AA to be less than 1 mm has become a future trend. At present, a GOA on source electrode driver side (GOA in Source Border) technology, which can be used for achievement of a spliced display with a three sided ultra-narrow border, has become the hotspot of display industries.

### TECHNICAL ISSUE

With reference to FIGS. 1 and 2, wherein FIG. 1 is a schematic view of a wire layout of an embodiment of a conventional array substrate, and FIG. 2 is a schematic view of a wire layout of another embodiment of a conventional array substrate.

With reference to FIG. 1, a gate driver on array (GOA) circuits 11 and a source electrode driver circuit (not shown in the figures) are disposed on the same side, in other words, both are disposed on a source electrode driver side (Source Border) 101. Furthermore, a width of one sub-pixel (Sub_Pixel) 12 is used for layout of the GOA circuit 11 of one level. Between adjacent two of the GOA circuits 11, one gate electrode fanout wire (Gate Fanout) 13 and one data lines (Data Line) 14 are arranged parallelly and adjacently and extend in an AA region 100 of the display panel, which a G(Gate Fanout)D(Data Line) wiring method is employed. Specifically, one gate electrode fanout wire 13 and one data lines 14 extend adjacently and parallelly in a region between adjacent two of the sub-pixels 12. Such method of employing a width of one sub-pixel to implement layout of a GOA circuit of one level makes the width of the Source Border wider. Furthermore, the wiring method of the GD has an intermutually coupling (Couple) existing between the gate electrode fanout wire and the data lines, which causes the risk of display mura.

With reference to FIG. 2, a GOA circuit 21 and a source electrode driver circuit (not shown in the figures) are disposed on the same side, in other words, both are disposed on a source electrode driver side 201. Furthermore, a width of two horizontally adjacent sub-pixels 22 are used for layout of the GOA circuit 21 of one level. Two parallel data lines 241, 242 exist between adjacent two GOA circuits 21. One data line 241 and one gate electrode fanout wire 23 are arranged adjacently and parallelly and extend in the AA region 200 of the display panel. Another data line 242, after extending out a layout region of the GOA circuit 21, is folded toward a side away from the data line 241, and then extends in the AA region 200 of the display panel, namely, a normal circularly arranged pixel (Cyclic pixel) framework wiring method of G(Gate Fanout)D(Data Line)+D(Data Line) I used. Specifically, one gate electrode fanout wire 23 and one data lines 241 adjacently and parallelly extend a region between a first column and a second column of the sub-pixels 22 in adjacent three columns of the sub-pixels 22 (first two columns of a broken frame shown in the figure), another data line 242 extend between a region of the second column and a third column of the sub-pixels 22 in adjacent three columns of the sub-pixels 22 (later two columns of the broken frame shown in the figure). Such method using a width of two sub-pixels to implement layout of a GOA circuit of one level reduces a width of the Source Border. However the wiring method of the GD+D still has an intermutually coupling) existing between the gate electrode fanout wire and the data lines, which causes the risk of display mura.

### SUMMARY OF INVENTION

### Technical Solution

An objective of the present invention is to provide an array substrate and a display device which can reduce a width of a driver side of the source electrode and prevent an intermutually coupling between a gate electrode fanout wire and data lines to optimize a display effect.

To achieve the above objective, the present invention provides an array substrate divided into a display region and a source electrode driver region; wherein the array substrate comprises: a plurality of gate driver on array (GOA) circuits of levels disposed on a side of the source electrode driver region near the display region, wherein the GOA circuit of each level is connected to at least one scan line disposed in the display region through a gate electrode fanout wire; a plurality of data lines extending out from a side of the GOA circuit of the source electrode driver region away from the display region, passing through a region where the GOA circuit is located, and extending in the display region, wherein two of the data lines are disposed in a second gap region between the GOA circuits of adjacent two levels; and a plurality of pixel units arranged in an array in the display region, wherein two of the data lines or one of the gate electrode fanout wires is disposed in a first gap region between adjacent two columns of the pixel units, two of the data lines are parallel to one of the gate electrode fanout wires at an interval, and a layout width of the GOA circuit of each level is substantially equal to a sum of widths of adjacent two columns of the pixel units.

To achieve the above objective, the present invention also provides an array substrate divided into a display region and a source electrode driver region; wherein the array substrate comprises: a plurality of gate driver on array (GOA) circuits of levels disposed in the source electrode driver region, wherein the GOA circuit of each level is connected to at least one scan line disposed in the display region through a gate electrode fanout wire; a plurality of data lines extending out from the source electrode driver region and extending in the display region; and a plurality of pixel units arranged in an array in the display region, wherein two of the data lines or one of the gate electrode fanout wires is disposed in a first gap region between adjacent two columns of the pixel units, and two of the data lines are parallel to one of the gate electrode fanout wires at an interval.

To achieve the above objective, the present invention also provides a display device comprising an array substrate, the array substrate divided into a display region and a source electrode driver region; wherein the array substrate comprises: a plurality of gate driver on array (GOA) circuits of levels disposed in the source electrode driver region, wherein the GOA circuit of each level is connected to at least one scan line disposed in the display region through a gate electrode fanout wire; a plurality of data lines extending out from the source electrode driver region and extending in the display region; and a plurality of pixel units arranged in an array in the display region, wherein two of the data lines or one of the gate electrode fanout wires is disposed in a first gap region between adjacent two columns of the pixel units, and two of the data lines are parallel to one of the gate electrode fanout wires at an interval.

### Advantages

The present invention, by employing a flip pixel framework of a DD+G wiring method, and a design of a gate driver on array (GOA) disposed on source electrode driver side, prevents a gate electrode fanout wire and data lines from adjacently and parallelly extending into an AA region of the display panel, which lowers a coupling capacitor generated from the data lines on the gate electrode fanout wire, prevents a coupling from occurring between the gate electrode fanout wire and signal of the data lines, lowers signal ripple, avoids the risk of occurrence of display mura, which optimizes the display effect. Furthermore, because the two of the data lines parallelly extend in the AA region of the display panel, a difference between loading of the data lines has been reduced. The gate electrode fanout wire and two of the data lines are not adjacent to each other but parallelly extend in the AA region of the display panel, a loading of the gate electrode fanout wire is lowered. Furthermore, because the data lines are not adjacent to the gate electrode fanout wire, the data lines would not suffer coupling of gate electrode signals on the gate electrode fanout wire, which avoids distortion of data signals on the data lines, and further prevents the pixel unit from being filled with a wrong potential. Also the gate electrode fanout wire would not suffer coupling of the data signals on the data lines, which avoids a great ripple occurring on gate electrode signals on the gate electrode fanout wire to further prevent leakage of thin film transistors in the AA region. Using the width of two pixel units to perform a layout of a GOA circuit of one level effectively lowers a width of the source electrode driver region, achieves reduction of an area of a border region, and further facilitates achievement of a narrow border.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic view of a wire layout of an embodiment of a conventional array substrate;

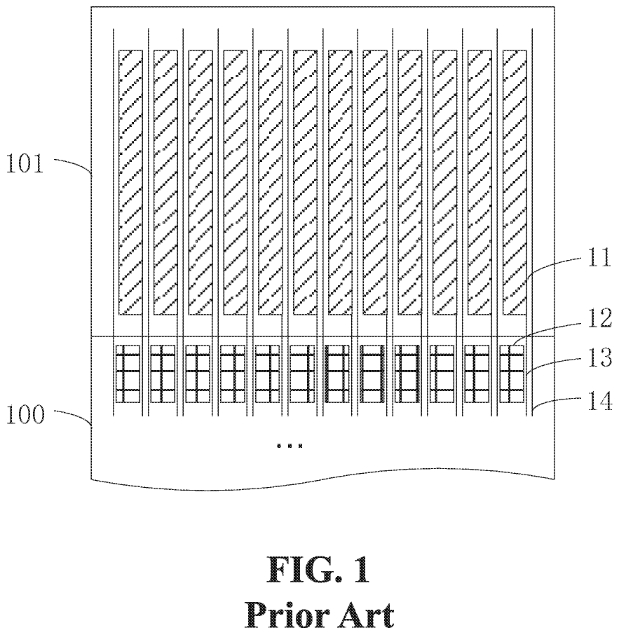

FIG. 2 is a schematic view of a wire layout of another embodiment of a conventional array substrate;

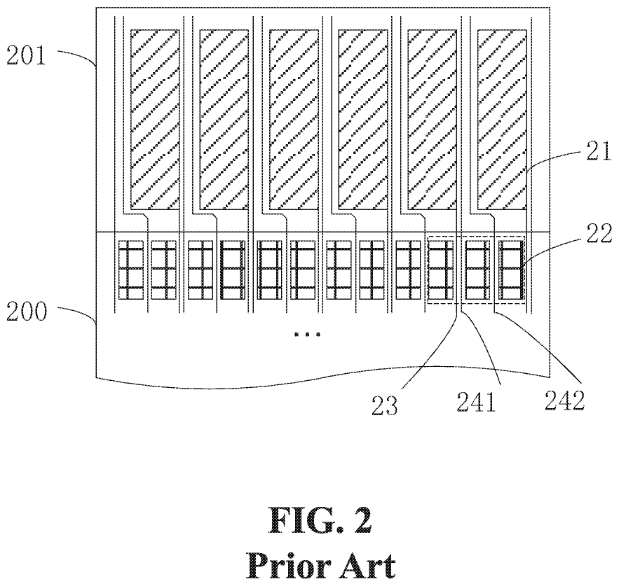

FIG. 3 is a schematic view of a wire layout of an embodiment of an array substrate of the present invention;

FIG. 4 is a schematic enlarged view of a portion A in FIG. 3;

FIG. 5 is a schematic view of a film structure of a portion B in FIG. 4; and

FIG. 6 is a schematic view of a structure of the display device of the present invention.

### DETAILED DESCRIPTION OF PREFERRED EMBODIMENTS

Embodiments of the present invention will be described in details. Examples of the embodiments are illustrated in the accompanying drawings. The same or similar reference characters refer to the same or similar elements or elements including the same or similar functions. The specification and claims of the present invention and terminologies “first”, “second”, “third”, etc. (if existing) in the above accompanying drawings are configured to distinguish similar objects and are not configured to describe a specific sequence or order thereof. It should be understood that such described objects can be exchanged with one another in an adequate condition. Furthermore, terminologies “include”, “have” and any variant thereof are intended to inclusive inclusion instead of exclusive inclusion. the present invention Directional terminologies mentioned by the present invention, for example “upper”, “lower”, “front”, “rear”, “left”, “right”, “top”, “bottom”, etc., only refer to directions of the accompanying drawings.

In the description of the present invention, it should be noted that unless clear rules and limitations otherwise exist, terminologies “connect”, “connection” should be understood in a broad sense. For instance, the connection can be a fixed connection, a detachable connection or an integral connection. The connection can be an electrical connection or a telecommunication. The connection can be a direct connection, an indirect connection through an intermedium. For a person of ordinary skill in the art, the specific meaning of the above terminology in the present invention can be understood on a case-by-case basis.

The present invention changes a cyclically arranged pixel (Cyclic pixel) framework of a G(Gate Fanout)D(Data Line)+D(Data Line) method in a conventional common design to a design using a flip pixel framework of a (Data Line)D(Data Line)+G(Gate Fanout) method an having the gate driver on array (GOA) disposed on the source electrode driver side (GOA in Source Border). The DD+G wiring method of the present invention can prevent the gate electrode fanout wire (Gate Fanout) and the data lines (Data Line) from parallelly extending in the AA region of the display panel such that a coupling capacitor generated from the data lines on the gate electrode fanout wire is reduced to prevent coupling between the gate electrode fanout wire and the data lines signal and lower signal ripple (Ripple), which optimizes the display effect because the two of the data lines parallelly extend in the AA region of the display panel, a difference between loading of the data lines has been reduced. The gate electrode fanout wire and two of the data lines are not adjacent to each other but parallelly extend in the AA region of the display panel, a loading of the gate electrode fanout wire is lowered. Furthermore, because the data lines are not adjacent to the gate electrode fanout wire, the data lines would not suffer coupling of gate electrode signals on the gate electrode fanout wire, which avoids distortion of data signals on the data lines, and further prevents the pixel unit from being filled with a wrong potential. Also the gate electrode fanout wire would not suffer coupling of the data signals on the data lines, which avoids a great ripple occurring on gate electrode signals on the gate electrode fanout wire to further prevent leakage of thin film transistors in the AA region. Using the width of two pixel units to perform a layout of a GOA circuit of one level effectively lowers a width of the source electrode driver region, achieves reduction of an area of a border region, and further facilitates achievement of a narrow border.

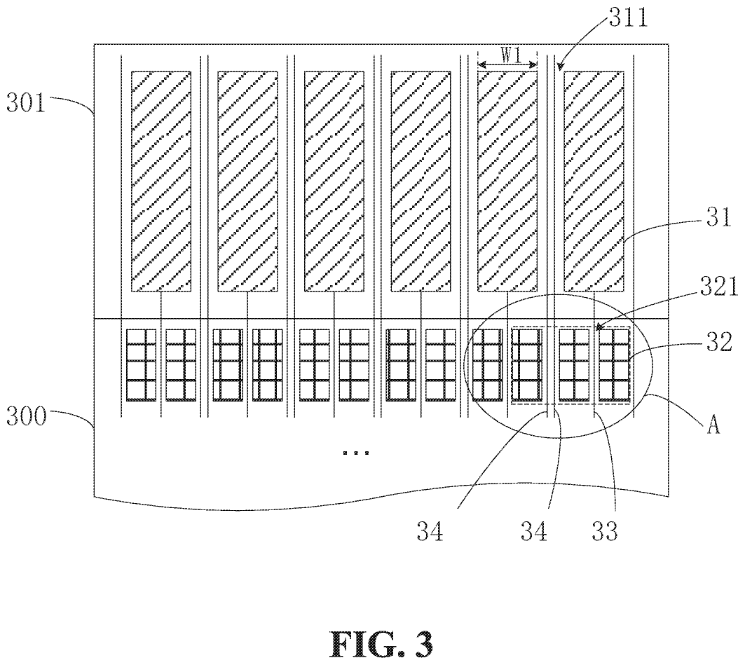

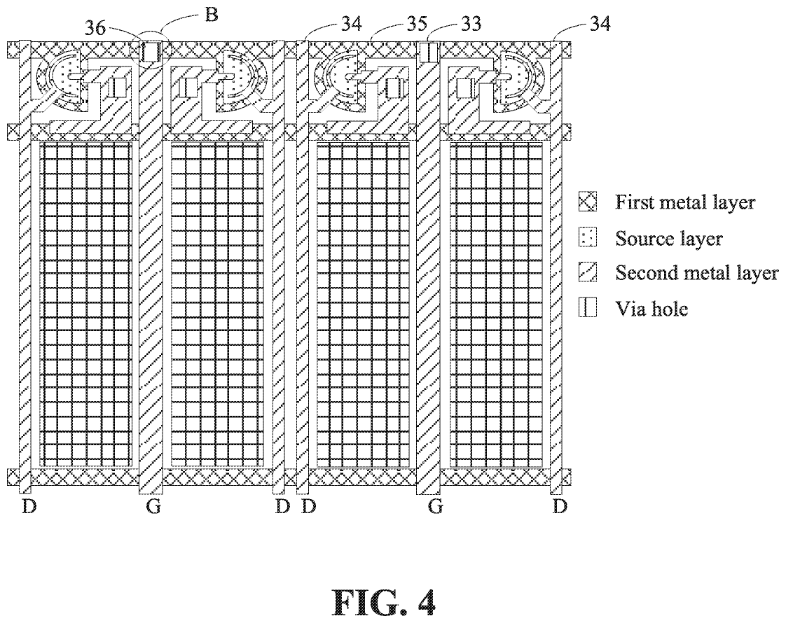

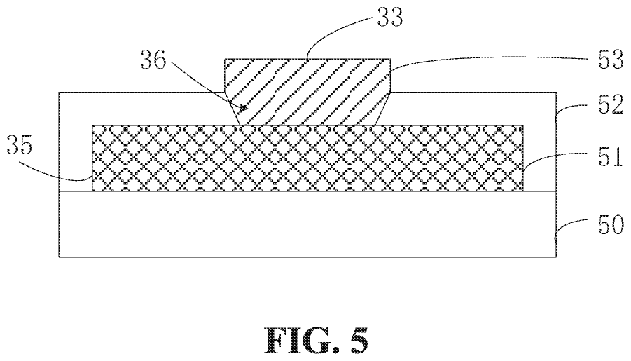

With reference to FIGS. 3 to 5, wherein FIG. 3 is a schematic view of a wire layout of an embodiment of an array substrate of the present invention, FIG. 4 is a schematic enlarged view of a portion A in FIG. 3, and FIG. 5 is a schematic view of a film structure of a portion B in FIG. 4.

With reference to FIG. 3, an array substrate of the present invention are divided in a display region 300 and a source electrode driver region 301. The array substrate comprises: GOA circuits 31 of levels, a plurality of pixel unit 32, a plurality of gate electrode fanout wires 33, and a plurality of data lines 34.

The GOA circuits 31 of levels are disposed in the source electrode driver region 301. The GOA circuit 31 of each level is connected to the at least one scan line 35 (shown in FIG. 4) disposed in the display region 300 through one of the gate electrode fanout wires 33. Specifically, the GOA circuit 31 is disposed a side of the source electrode driver region 301 near the display region 300. The GOA circuit 31 is configured to provide a gate electrode of a thin film transistor (TFT) of a corresponding pixel unit 32 with Gate signals through the gate electrode fanout wire 33, the scan line 35 to make the display device to perform display scan.

The data lines 34 extend out from the source electrode driver region 301 and extend in the display region 300. Specifically, the data lines 34 extend out from a side of the GOA circuit 31 away from the display region 300 in the source electrode driver region 301, passes through a region where the GOA circuit 31 is located, and extend in the display region 300. The data lines 34 is configured to provide a drain electrode of the TFT of the pixel unit 32 with Data signals. Specifically, data lines entering the the display region 300 correspond to output channels of the source electrode driver unit (Source Driver) disposed in the source electrode driver region 301. Also the source electrode driver unit provides Data signals.

Specifically, the GOA circuit 31 and the source electrode driver unit are configured for a source electrode driver (Source Driver) and a gate electrode driver (Gate Driver) in the display panel respectively to output corresponding signals to the display panel to drive the display panel to display. The GOA circuit 31 and the source electrode driver unit are also connected to a chip-on-film, another end of the chip-on-film is connected to a printed circuit board (PCB) to receive corresponding signals transmitted from the PCB to achieve reliable transmission of display panel driver signals and reduce a size of a bonding region, which facilitates achievement the ultra-narrow border or border free configuration of the liquid crystal display panel.

The pixel unit 32 are arranged in an array in the display region 300. Two of the data lines 34 or one of the gate electrode fanout wires 33 are disposed in a first gap region 321 of adjacent two columns of the pixel units 32 of. The two data lines 34 and the gate electrode fanout wires 33 are arranged parallelly at intervals. Namely, a wiring method of D(Data Line)D(Data Line)+G(Gate Fanout)(i.e., DD+G) is employed.

Specifically, in adjacent three columns of the pixel units 32 (the three columns of a broken frame in the figure), two of the data lines 34 are disposed on a first gap region 321 between a first column and a second column of the pixel units 32 (the former two columns of a broken frame in the figure). One of the gate electrode fanout wires 33 is disposed in the first gap region 321 between the second column and a third column of the pixel units 32 (the later two columns of a broken frame in the figure). The two data lines 34 are parallel and adjacent to each other, the gate electrode fanout wire 33 and the data lines 34 are parallel but not adjacent to each other. the above arrangement is cyclically implemented. Namely, two of the data lines 34 adjacently and parallelly extend in the region between the first and second columns of the pixels unit 32, and the gate electrode fanout wires 33 extends in the region between the second and third columns of the pixel units 32. Such DD+G wiring method avoids the risk of display mura generated by intermutually coupling between the gate electrode fanout wire and the data lines, avoids data signal distortion on the data lines, and further obviates great ripple occurring on gate electrode signals on the gate electrode fanout wire.

In a further embodiment, in the display region 300, a width of each of the pixel units 32 is consistent to guarantee display uniformity of the entire display device, which optimizes the display effect.

In a further embodiment, the GOA circuit 31 of each level [symbol] layout width W1 is substantially equal to a sum of widths of adjacent two columns of the pixel units 32. Namely, the method of the present invention using the width of the two pixel units (i.e., sub-pixel) to perform a layout of a GOA circuit of one level effectively reduces a width of source electrode driver region, achieves reduction of an area of the border region, and further facilitates achievement of the narrow border. Specifically, compared to a conventional method using a width of one pixel unit to perform a layout of a GOA circuit of one level, the present invention uses the width of two pixel units to perform a layout of a GOA circuit of one level, and a length of the GOA circuit layout can be reduced to two-thirds of the conventional GOA circuit layout.

In a further embodiment, the gate electrode fanout wire 33 extends out from a middle of a side of the GOA circuit 31 near the display region 300. Because of the method of using the width of two pixel units is used to perform a layout of a GOA circuit of one level, a middle of a side of the GOA circuit 31 near the display region 300 substantially corresponds to the first gap region 321 between adjacent two columns of the pixel units 32 such that the extending gate electrode fanout wire 33 and the data lines 34 can parallelly enter the display region 300, which simplifies and easily achieves the wiring.

In a further embodiment, two of the data lines 34 are disposed in a second gap region 311 between adjacent two levels of the GOA circuits 31. Namely, two of the data lines 34 adjacently and parallelly extend out from a side of the GOA circuit 31 in the source electrode driver region 301 away from the display region 300, passes through the second gap region 311 between adjacent two levels of the GOA circuits 31, and extend in the display region 300, which simplifies and easily achieves the wiring.

In a further embodiment, a wire width of the gate electrode fanout wire 33 is substantially twice a wire width of the data lines 34 to fully utilize a layout space to improve signal transmission efficiency.

In a further embodiment, the data lines 34 and the gate electrode fanout wire 33 are located in the same metal layer and are insulated from each other. Namely, a patterning process can be implemented on the same metal layer to form corresponding data lines and gate electrode fanout wire, which simplifies the processes.

In a further embodiment, the data lines 34 are perpendicular to the scan line 35 and are located in different metal layers. Namely, the data lines and scan line can be formed by implementing patterning processes on different metal layers. The formed data lines are perpendicular to and are insulated from the scan line for transmitting different signals.

In a further embodiment, the pixel units 32 employ a flip pixel framework, as shown in FIG. 4. Specifically, with reference to FIG. 4, two columns of the pixel units 32 on two sides of the gate electrode fanout wire 33 respectively are axisymmetric relative to the gate electrode fanout wire 33.

In a further embodiment, the gate electrode fanout wire 33 and the scan line 35 are located in different metal layers, and are connected to the scan line 35 through a via hole 36, as shown in FIG. 4. Specifically, an interlayer insulation layer 52 (shown in FIG. 5) is disposed between the different metal layers, the gate electrode fanout wire 34 is connected to the scan line 35 through the via hole 36 defined in the interlayer insulation layer 52.

With reference to FIG. 5, the array substrate comprises: a first metal layer 51, an interlayer insulation layer 52, and a second metal layer 53. Specifically, the first metal layer 51 can be disposed on an underlay substrate 50. The scan line 35 is located on the first metal layer 51, namely, a patterning process is implemented on the first metal layer 51 to form the scan line 35. The interlayer insulation layer 52 is disposed on the first metal layer 51, and a plurality of via holes 36 are defined in the interlayer insulation layer 52. The via holes 36 can be defined through the interlayer insulation layer 52 by an etching process such that during later deposition of metal material for manufacturing the second metal layer 53, the deposited metal material can contact the first metal layer 51 through the via hole 36. The second metal layer 53 is disposed on the interlayer insulation layer 52. The gate electrode fanout wire 33 is located on the second metal layer 52, and the gate electrode fanout wire 33 is connected to the scan line 35 through the via hole 36. Namely, implementing the patterning process on the second metal layer 52 forms the the gate electrode fanout wire 33, and the gate electrode fanout wire 33 is connected to the scan line 35 through the via hole 36. Implementing the patterning process on the second metal layer 52 also forms the data lines 34 parallel to and insulated from the gate electrode fanout wire 33.

On the basis of the same inventive concept, the present invention also provides a display device employing the array substrate of the present invention.

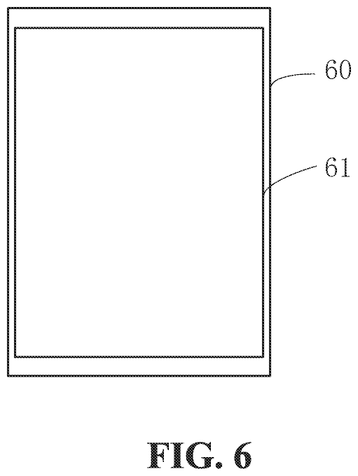

With reference to FIG. 6, FIG. 6 is a schematic view of a structure of the display device of the present invention. The display device 60 comprises an array substrate 61. The array substrate 61 employs the array substrate of the present invention, a specific structure thereof can refer to FIGS. 3 to 5 and will not be described repeatedly herein. The display device 60 can be a liquid crystal display device, such as a display, a television, a mobile phone, a tablet, etc.

An array substrate of the present invention is employed, because the two of the data lines parallelly extend in the AA region of the display panel, a difference between loading of the data lines has been reduced. The gate electrode fanout wire and two of the data lines are not adjacent to each other but parallelly extend in the AA region of the display panel, a loading of the gate electrode fanout wire is lowered. Furthermore, because the data lines are not adjacent to the gate electrode fanout wire, the data lines would not suffer coupling of gate electrode signals on the gate electrode fanout wire, which avoids distortion of data signals on the data lines, and further prevents the pixel unit from being filled with a wrong potential. Also the gate electrode fanout wire would not suffer coupling of the data signals on the data lines, which avoids a great ripple occurring on gate electrode signals on the gate electrode fanout wire to further prevent leakage of thin film transistors in the AA region. Using the width of two pixel units to perform a layout of a GOA circuit of one level effectively lowers a width of the source electrode driver region, achieves reduction of an area of a border region, and further facilitates achievement of a narrow border.

It can be understood that for a person of ordinary skill in the art, equivalent replacements or changes can be made according to the technical solution of the present invention and its inventive concept, and all these changes or replacements should belong to the scope of protection of the appended claims of the present invention.

What is claimed is:

1. An array substrate, divided into a display region and a source electrode driver region; wherein the array substrate comprises:
a plurality of gate driver on array (GOA) circuits of levels disposed on a side of the source electrode driver region near the display region, wherein the GOA circuit of each level is connected to at least one scan line disposed in the display region through a gate electrode fanout wire;
a plurality of data lines extending out from a side of the GOA circuit of the source electrode driver region away from the display region, passing through a region where the GOA circuit is located, and extending in the display region, wherein two of the data lines are disposed in a second gap region between the GOA circuits of adjacent two levels; and
a plurality of pixel units arranged in an array in the display region, wherein two of the data lines or one of the gate electrode fanout wires is disposed in a first gap region between adjacent two columns of the pixel units, two of the data lines are parallel to one of the gate electrode fanout wires at an interval, and a layout width of the GOA circuit of each level is substantially equal to a sum of widths of adjacent two columns of the pixel units.

2. The array substrate as claimed in claim 1, wherein the gate electrode fanout wires extend out from a middle of a side of the GOA circuit near the display region.

3. The array substrate as claimed in claim 1, wherein the pixel units employ an overturn pixel framework.

4. The array substrate as claimed in claim 1, wherein two columns of the pixel units located on two sides of each of the gate electrode fanout wires respectively are axially symmetric relative to the gate electrode fanout wire.

5. The array substrate as claimed in claim 1, wherein the array substrate comprises:
a first metal layer, and the scan line located on the first metal layer;
an interlayer insulation layer disposed on the first metal layer, and a plurality of via holes defined through the interlayer insulation layer; and
a second metal layer disposed on the interlayer insulation layer, both the data lines and the gate electrode fanout wires located on the second metal layer, the gate electrode fanout wires connected to the scan line through the via holes, and the data lines and the gate electrode fanout wires located in the same metal layer and insulated from each other.

6. An array substrate, divided into a display region and a source electrode driver region; wherein the array substrate comprises:
a plurality of gate driver on array (GOA) circuits of levels disposed in the source electrode driver region, wherein the GOA circuit of each level is connected to at least one scan line disposed in the display region through a gate electrode fanout wire;
a plurality of data lines extending out from the source electrode driver region and extending in the display region; and
a plurality of pixel units arranged in an array in the display region, wherein two of the data lines or one of the gate electrode fanout wires is disposed in a first gap region between adjacent two columns of the pixel units, and two of the data lines are parallel to one of the gate electrode fanout wires at an interval.

7. The array substrate as claimed in claim 6, wherein a layout width of the GOA circuit of each level is substantially equal to a sum of widths of adjacent two columns of the pixel units.

8. The array substrate as claimed in claim 6, wherein the gate electrode fanout wires extend out from a middle of a side of the GOA circuit near the display region.

9. The array substrate as claimed in claim 6, wherein the GOA circuits of levels disposed on a side of the source electrode driver region near the display region; and the data lines extending out from a side of the GOA circuit of the source electrode driver region away from the display region, passing through a region where the GOA circuit is located, and extending in the display region.

10. The array substrate as claimed in claim 6, wherein two of the data lines are disposed in a second gap region between the GOA circuits of adjacent two levels.

11. The array substrate as claimed in claim 6, wherein the pixel units employ an overturn pixel framework.

12. The array substrate as claimed in claim 6, wherein two columns of the pixel units located on two sides of each of the gate electrode fanout wires respectively are axially symmetric relative to the gate electrode fanout wire.

13. The array substrate as claimed in claim 6, wherein the data lines and the gate electrode fanout wires located in the same metal layer and insulated from each other.

14. The array substrate as claimed in claim 6, wherein the data lines are perpendicular to the scan line and are located in different metal layers.

15. The array substrate as claimed in claim 6, wherein the array substrate comprises:
a first metal layer, and the scan line located on the first metal layer;
an interlayer insulation layer disposed on the first metal layer, and a plurality of via holes defined through the interlayer insulation layer; and
a second metal layer disposed on the interlayer insulation layer, both the data lines and the gate electrode fanout wires located on the second metal layer, the gate electrode fanout wires connected to the scan line through the via holes, and the data lines insulated from the gate electrode fanout wires.

16. A display device, comprising an array substrate, the array substrate divided into a display region and a source electrode driver region; wherein the array substrate comprises:
a plurality of gate driver on array (GOA) circuits of levels disposed in the source electrode driver region, wherein the GOA circuit of each level is connected to at least one scan line disposed in the display region through a gate electrode fanout wire;
a plurality of data lines extending out from the source electrode driver region and extending in the display region; and
a plurality of pixel units arranged in an array in the display region, wherein two of the data lines or one of the gate electrode fanout wires is disposed in a first gap region between adjacent two columns of the pixel units, and two of the data lines are parallel to one of the gate electrode fanout wires at an interval.

17. The display device as claimed in claim 16, wherein a layout width of the GOA circuit of each level is substantially equal to a sum of widths of adjacent two columns of the pixel units.

18. The display device as claimed in claim 16, wherein two of the data lines are disposed in a second gap region between the GOA circuits of adjacent two levels.

19. The display device as claimed in claim 16, wherein the pixel units employ an overturn pixel framework.

20. The display device as claimed in claim 16, wherein the array substrate comprises:
a first metal layer, and the scan line located on the first metal layer;
an interlayer insulation layer disposed on the first metal layer, and a plurality of via holes defined through the interlayer insulation layer; and
a second metal layer disposed on the interlayer insulation layer, both the data lines and the gate electrode fanout wires located on the second metal layer, the gate electrode fanout wires connected to the scan line through the via holes, and the data lines insulated from the gate electrode fanout wires.
